(19) United States
(12) Patent Application Publication
(10) Pub. No.: US 2007/0240936 A1
(43) Pub. Date: Oct. 18, 2007

(54) Automatically deployable and retractable rear ladder, particularly for emergency vehicles

(76) Inventors: Curtis B. Brookshire JR., Washington, NC (US); Douglas M. LaFauci, Mt. Penn, PA (US); Gary L. Eckman, Willow Street, PA (US)

Correspondence Address: WITHROW & TERRANOVA, P.L.L.C., 100 REGENCY FOREST DRIVE, SUITE 160, CARY, NC, 27518, US

(21) Appl. No.: 11/403,627

(22) Filed: Apr. 13, 2006

(51) Int. Cl. E06C 5/00

(52) U.S. Cl. 182/127

(57) ABSTRACT

A two-rail rear ladder system that automatically deploys and retracts a ladder from a vehicle, such as an emergency vehicle. The ladder is deployable and retractable with minimal or no human intervention, thereby saving time and/or creating less risk for injury. The ladder is deployed from the rear of a vehicle and rests at an angle on the ground when fully deployed. A two-stage drive unit system is used to deploy and retract the ladder. One drive unit deploys and retracts the ladder on a first rail to a position where the ladder tilts towards the ground. The second drive unit deploys and retracts the ladder from the tilted position to and from the ground on a second rail. Only a partial portion of the ladder's length is required to be deployed before the ladder will tilt downward towards the ground thereby minimizing open space needed behind the vehicle to deploy the ladder.

### FIELD OF THE INVENTION

The present invention relates to an automatically deployable and retractable ladder device, system, and method for use on vehicles, particularly emergency vehicles.

### BACKGROUND OF THE INVENTION

It is common to provide a ladder at the rear of a truck or vehicle, and in particular an emergency related vehicle, for access to the roof. Storage compartments and other necessary items may be stored on top of the vehicle. This type of ladder is commonly referred to as a rear ladder. Most rear ladders are fixedly attached in a vertical arrangement to the rear of the vehicle. The ladder is typically comprised of handrails that are attached and run substantially parallel to the rear of the vehicle with perpendicular steps therebetween. Persons desiring to access the roof of the vehicle scale the ladder until they reach the roof of the vehicle.

Because these fixedly mounted rear ladders are parallel to the rear of the vehicle, it is more difficult to scale the ladder. The person scaling the ladder is climbing directly upward instead of at an angle, thereby requiring more strength to scale the ladder. Further, because the ladder is vertical, the person scaling the ladder must also support themselves by grabbing the handrails. The person scaling the ladder must not only posses the strength to scale the ladder vertically, but must also balance themselves from falling backward off the ladder.

Because of these issues, rear-angled ladders have been developed. An angled rear ladder is one where the top of the ladder rests against the rear of the vehicle, and the bottom of the ladder extends outward, away from the vehicle, touching the ground. For example, the ladder may be angled at a 45 degree angle with respect to the ground, as opposed to a 90 degree angle like that of a vertical ladder fixedly attached to the rear of the vehicle. The steps on such rear-angled ladders may encompass the form of steps in a staircase fashion rather than more narrow rods or steps found on a vertical rear ladder. However, many of these rear-angled ladders must be manually deployed. When not deployed, the ladder rests on top or on the roof of the vehicle. When service personnel desires to employ the ladder, the service personnel must access the roof of the vehicle, sometimes through a separate vertical ladder, to retrieve the ladder from storage and deploy the ladder off the rear of the vehicle in an angled manner. Not only can this task be time consuming, but it can also create the potential for injury or other dangers.

U.S. Pat. No. 5,632,591 (hereinafter the “'591 patent”) discloses one example of automated as opposed to manual deployable and retractable rear ladder system. However, the ladder in the '591 employs a support carriage that must pivot in order to lower the ladder in the rear of the vehicle during deployment. The carriage must pivot, because only one drive system is used to deploy and retract the ladder for both the diagonal and horizontal positions of the ladder. If the pivot arm fails, the ladder cannot be deployed. Further, in the '591 patent, the roof of the vehicle must have enough room to support the entire length of the ladder thereby possibly making it unpractical for shorter length vehicles. During retraction, the ladder is only secured to the roof once the ladder is fully retracted and reaches the hood located towards the front of the vehicle. Further, because the ladder is comprised of one continuous section, the ladder may be unknowingly deployed on the ground at places that are not recognized by service personnel as uneven or not stable until the ladder is traversed thereby creating more potential for accidents.

Therefore, the object of the invention is to provide an automatic deployable and retractable rear ladder that does not suffer from the aforementioned deficiencies.

### SUMMARY OF THE INVENTION

The present invention is directed to a two-rail rear-angled ladder that is automatically deployable and retractable with minimal or no human intervention, thereby saving time and/or creating less risk for injury. The ladder is deployed from the rear of a vehicle. Only a partial portion of the ladder's length is required to be deployed before the ladder will tilt downward towards the ground. This minimizes open space needed behind the vehicle to deploy the ladder and reduces safety hazards caused as a result of deploying or retracting a full length ladder.

The ladder is secured to the roof of the vehicle using a rail system to ensure that the ladder is secured to the roof during the retraction process up and until the ladder is ready to be tilted downward for ground deployment. In order to deploy and retract the ladder of the present invention, a two-stage process is used that employs two separate drive units and two-rail systems to retract the ladder. During deployment, the first or carriage motor drive unit deploys the ladder by driving a carriage along a roof rail system supporting a ladder rail that supports the ladder. The ladder rail is driven outward along a roof rail from the rear of the vehicle from its resting position on and substantially parallel to roof of the vehicle. The ladder and ladder rail are designed to tilt downward after the ladder rail supporting the ladder is partially disengaged from the roof rail.

Thereafter, a second or ladder motor drive unit attached to the ladder rail deploys the ladder along a second ladder rail system toward the ground at the titled angle away from the vehicle. In this manner, open space required for deployment of the ladder is minimized to prevent accidents caused by deploying and retracting the ladder. Further, by employing the two drive system, the carriage does not have to tilt or pivot to fully deploy the ladder.

The ladder also contains a bottom section that is hingedly attached to a top section of the ladder. In this manner, the bottom section of the ladder can be flipped onto the top section of the ladder to minimize storage space when using a ladder that may otherwise be too long for the vehicle roof. Further, this allows the top section of the ladder to be fully deployed without the top section touching the ground during the automatic deployment process so that persons do not traverse the latter where the ladder ground contact is unknowingly believed to be stable. After full deployment, the bottom section can be flipped open to engage the ladder with ground in a controlled manner. This decreases the likelihood someone will traverse the ladder without the ladder being coupled to the ground in a stable manner.

In a second ladder embodiment, two carriage screw shafts rather than one carriage screw shaft are provided to move the carriage along the roof rail. The two carriage screw shafts are provided on each side of a center axis through the carriage drive. In this manner, the carriage screw shafts are moved out of the walking area of the roof of the vehicle. The carriage drive unit drives both the carriage screw shafts at the same time in unison to move the carriage along the roof to deploy and retract the ladder. Providing two carriage screw shafts allows the carriage drive unit to move the carriage and thus the ladder more slowly for greater control during deployment and retraction.

A handrail and bottom section ladder locking system may also be employed so that these items are securely locked in place when the ladder is deployed and to be used. A spring-loaded dead bolt system is employed. A locking handle is attached to a dead bolt and is used to extend the dead bolt through orifices located on opposite sides of the ladder for the bottom section of the ladder locking system, and through orifices in the handrail posts for the handrails in the handrail locking system. The handle is pushed to lock the deadbolt in place when locking is desired to prevent the bottom section of the ladder and the handrails from being retracted in a storage position.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is an illustration of the automatically deployable and retractable rear ladder of the present invention when fully deployed;

FIG. 2A is a front perspective view illustration of the ladder fully deployed;

FIG. 2B is a rear perspective view illustration of the ladder fully deployed;

FIG. 2C is a close up illustration of ladder motor drive unit for deploying and retracting the top section of the ladder from a parallel to an angled position with respect to the vehicle roof;

FIG. 2D is a top view illustration of the ladder illustrated in FIGS. 2A-2C;

FIG. 3A is a front perspective view illustration of the ladder raised to an almost parallel position for retraction along the roof rail;

FIG. 3B is a bottom perspective view illustration of the ladder illustrated in FIG. 3A;

FIG. 3C is a side view illustration of the ladder illustrated in FIG. 3A;

FIG. 4A is a front perspective view illustration of the ladder raised to a parallel position for retraction along the roof rail;

FIG. 4B is a side view illustration of the ladder illustrated in FIG. 4A;

FIG. 5A is a front perspective view illustration of the ladder fully retracted along the roof rail;

FIG. 5B is a rear perspective view illustration of the ladder fully retracted along the roof rail;

FIG. 5C is a top view of the ladder illustrated in FIGS. 5A and 5B;

FIG. 5D is a side view of the ladder illustrated in FIGS. 5A-5C;

FIG. 6A is a front perspective view illustration of an alternative ladder embodiment fully deployed;

FIG. 6B is a rear perspective view illustration of the alternative ladder embodiment fully deployed;

FIG. 6C is a close up illustration of the ladder motor drive unit for deploying and retracting the top section of the alternative ladder embodiment from a parallel to an angled position with respect to the vehicle roof;

FIG. 6D is a top view illustration of the alternative ladder embodiment illustrated in FIGS. 6A-6C;

FIG. 7A is a front perspective view illustration of the alternative ladder embodiment raised to an almost parallel position for retraction along the roof rail;

FIG. 7B is a bottom perspective view illustration of the alternative ladder embodiment illustrated in FIG. 7A;

FIG. 7C is a side view illustration of the alternative ladder embodiment illustrated in FIG. 7A;

FIG. 8A is a front perspective view illustration of the alternative ladder embodiment raised to a parallel position for retraction along the roof rail;

FIG. 8B is a side view illustration of the alternative ladder embodiment illustrated in FIG. 8A;

FIG. 9A is a front perspective view illustration of the alternative ladder embodiment fully retracted along the roof rail;

FIG. 9B is a rear perspective view illustration of the alternative ladder embodiment fully retracted along the roof rail;

FIG. 9C is a top view of the alternative ladder embodiment illustrated in FIGS. 9A and 9B; and

FIG. 9D is a side view of the alternative ladder embodiment illustrated in FIGS. 9A-9C.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

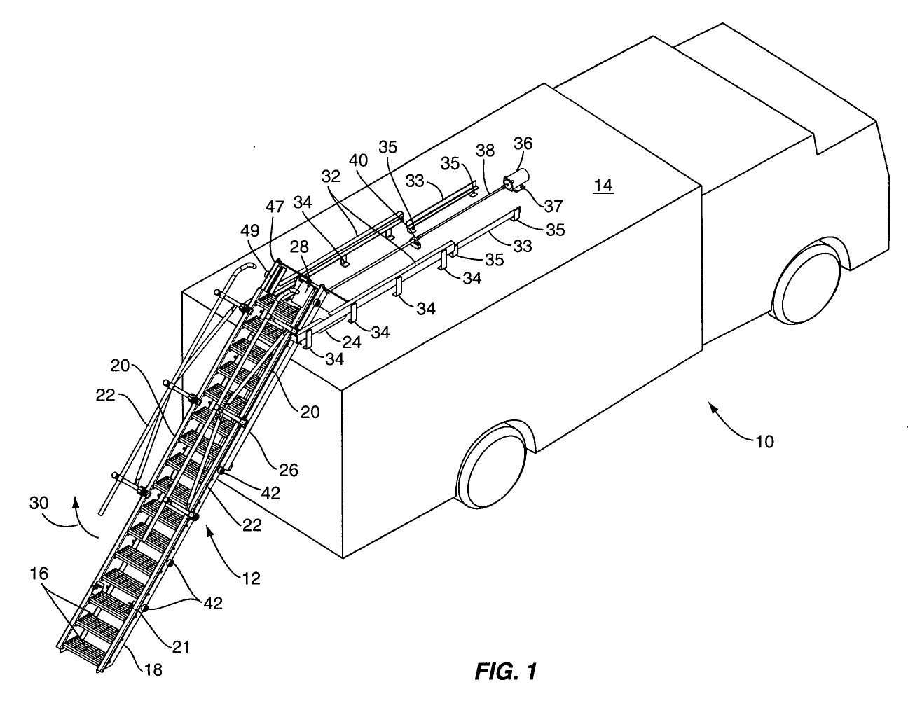

The drawings of the application illustrate the ladder in its fully deployed position through a retraction process until fully stored on the roof of the vehicle. Thus, deployment of the ladder occurs in reverse and thus the discussion below also inherently discloses the deployment process. An overview of the ladder and the components that allow for its deployment and retraction will be described generally in the description of FIG. 1 below. The remainder of the application will illustrate the ladder in various views during the retraction process.

FIG. 1 illustrates a general view of the ladder in its fully deployed position on a vehicle. A vehicle 10 is provided that contains a ladder 12. The vehicle 10 may be an emergency vehicle including a fire truck, for example. The vehicle 10 includes a roof 14 which is used to support the ladder 12 when retracted and/or other compartments for storage purposes. The ladder 12 is comprised of a plurality of steps 16 that are used to support a person traversing the ladder 12. The steps 16 may be solid, perforated, and/or stair case type steps 12. The tops of the steps 16 may contain an anti-slip material or may consist of metal strips having uneven edges to provide a gripping surface to prevent falls when the ladder 12 is being traversed. The ladder 12 is further comprised of two sections. The first section is a bottom section 18, which is attached to a top section 20 of the ladder 12 via a hinge 21. In this manner, the bottom section 18 can flip up along the hinge 21 and rest on the top section 20 of the ladder 12, as will be illustrated later in this application. Providing the bottom section 18 of the ladder 12 that flips upward on the top section 20 allows for a longer ladder 12 to be stored on a shorter length roof 14.

The ladder 12 also contains handrails 22 that provide support to persons traversing the ladder 12. To retract the ladder 12, the top section 20 of the ladder 12 is pulled along a ladder rail 26 via a ladder motor drive unit 28. In one embodiment, the ladder motor drive unit 28 is a CDP3430-V12 model ½ HP motor manufactured by BALDOR. The ladder rail 26 is attached to a carriage 24 via a ladder-roof rail coupler 47. The ladder-roof rail coupler 47 is attached to the ladder rail 26. The ladder 12 contains rollers 42 that are designed to roll along inside of the ladder rail 26. When the ladder motor drive unit 28 is activated, the top section 20 of the ladder 12 (and its rollers 42) is pulled upward along the ladder rail 26 that guides its retraction upward at the angle of deployment. The rollers 42 may be manufactured out of rubber, plastic, or a hardened material.

When a portion of top section 20 of the ladder 12 extends sufficiently beyond the ladder rail 26 to tilt downward towards the roof of the vehicle via gravity in a clockwise rotation 30, the top section 20 of the ladder 12, and more particularly ladder-roof rail coupler rollers 49 attached to the ladder roof-rail coupler 47, will fall down into and be supported by a roof rail 32. The roof rail 32 is mounted to the roof 14 of the vehicle 12 via a roof rail mount 34. A secondary roof rail 33 is mounted to the roof 14 of the vehicle 12 via secondary roof rail mounts 35. The ladder 12 is designed so that the top section 20 of the ladder 12 does not tilt downward in a position parallel to the roof 14 during retraction until the front of the top section 12 is adjacent the secondary roof rail 33. The ladder-roof rail coupler rollers 42 may be manufactured out of rubber, plastic, or a hardened material.

Thereafter, in a second phase of the retraction process, the ladder 12 is parallel to the roof 14. A carriage motor drive unit 36, which is attached to the carriage 24 via a carriage screw shaft 38, pulls the carriage 24 forward in order to pull the top section 20 of the ladder 12 forward towards the cabin of the vehicle 10 along the roof rail 32, and into the secondary roof rail 33. The carriage motor drive unit 36 may be a CDP3430-V12 model ½ HP motor manufactured by BALDOR. The carriage 24 is attached to the ladder-roof rail coupler 47, which is attached to the ladder rail 26. Thus, pulling of the carriage 24 pulls the ladder 12 supported inside the ladder rail 26 forward. The carriage motor drive unit 36 is mounted to the roof 14 of the vehicle 12 via a carriage motor drive unit mount 37. Eventually, as the carriage motor drive unit 36 pulls upon carriage 24 to pull the top section 20 of the ladder 12 forward, the ladder 12 will hit a screw shaft stop 40 to prevent the ladder 12 from being pulled forward any further.

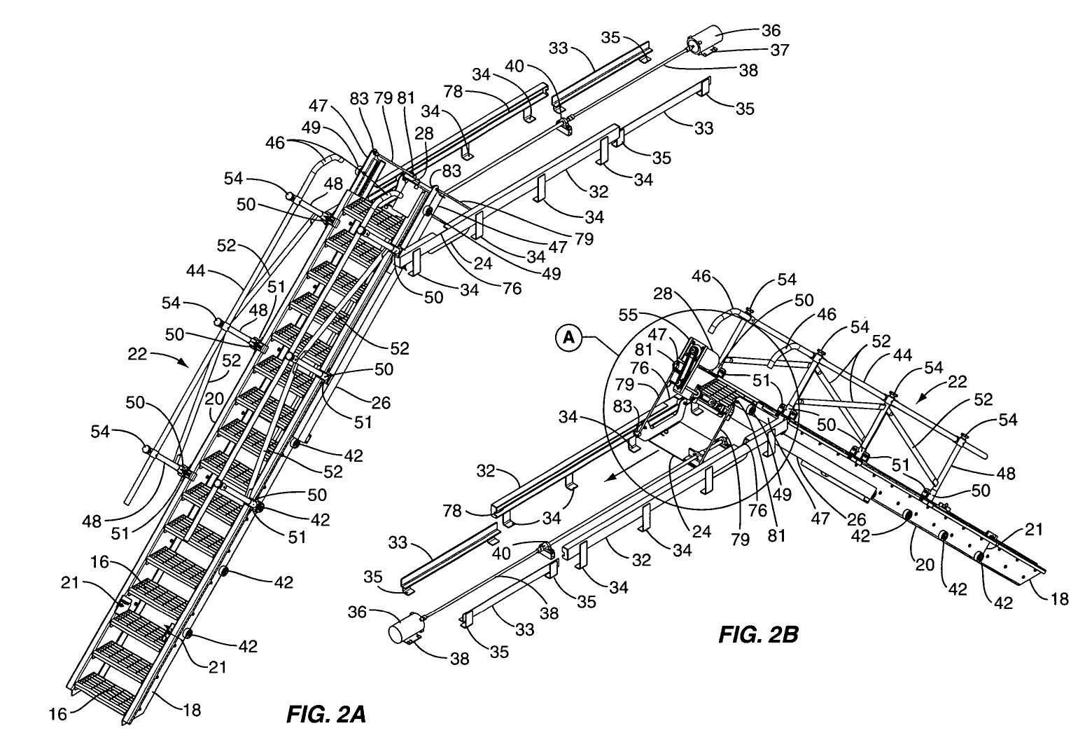

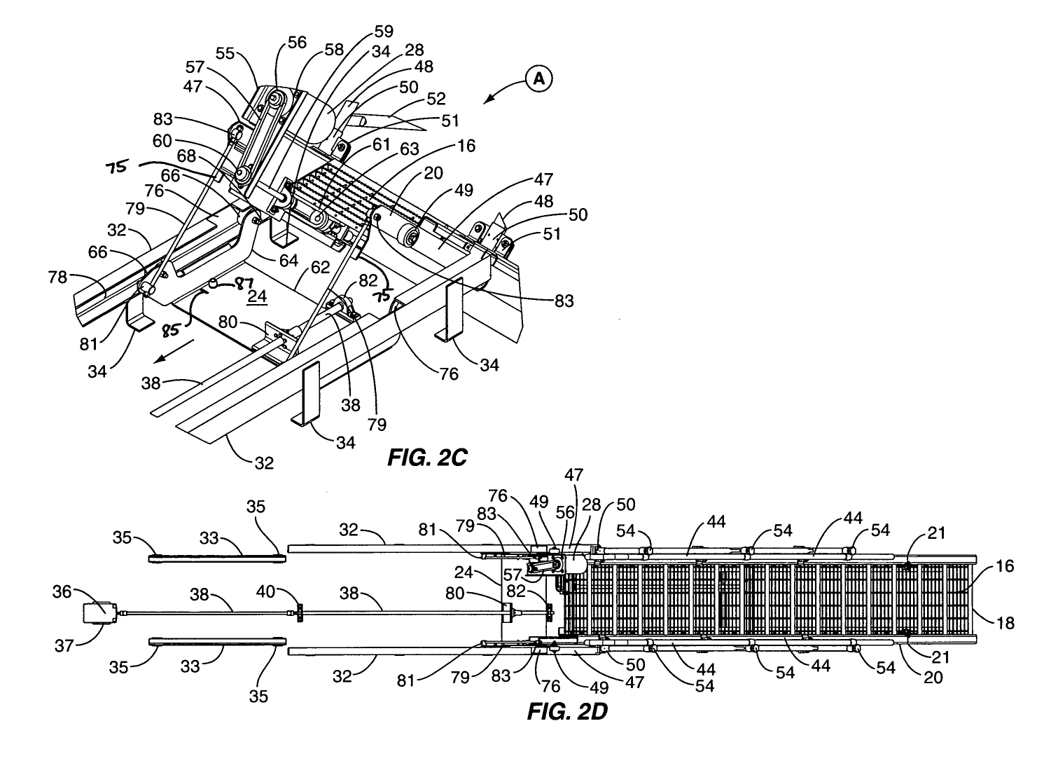

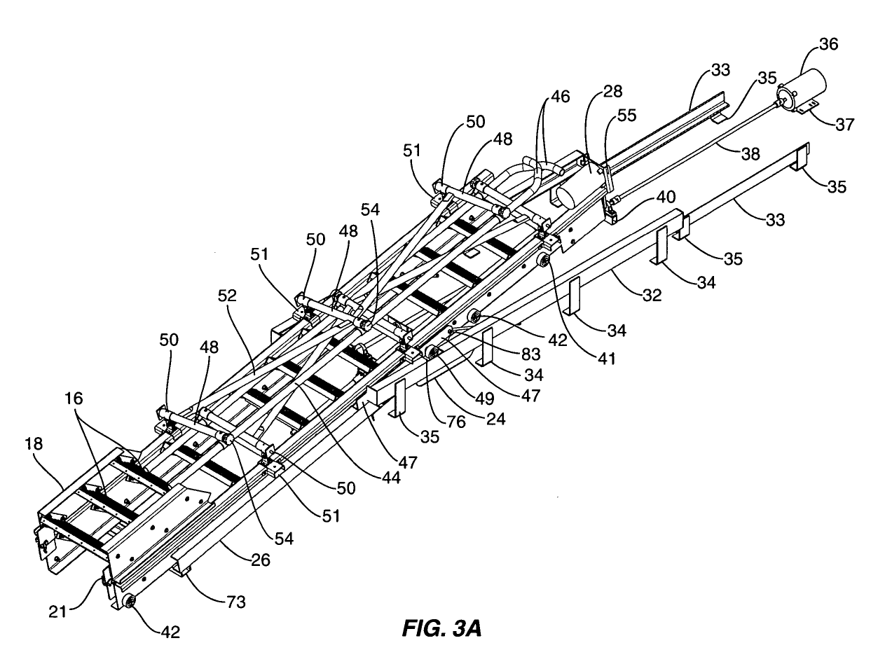

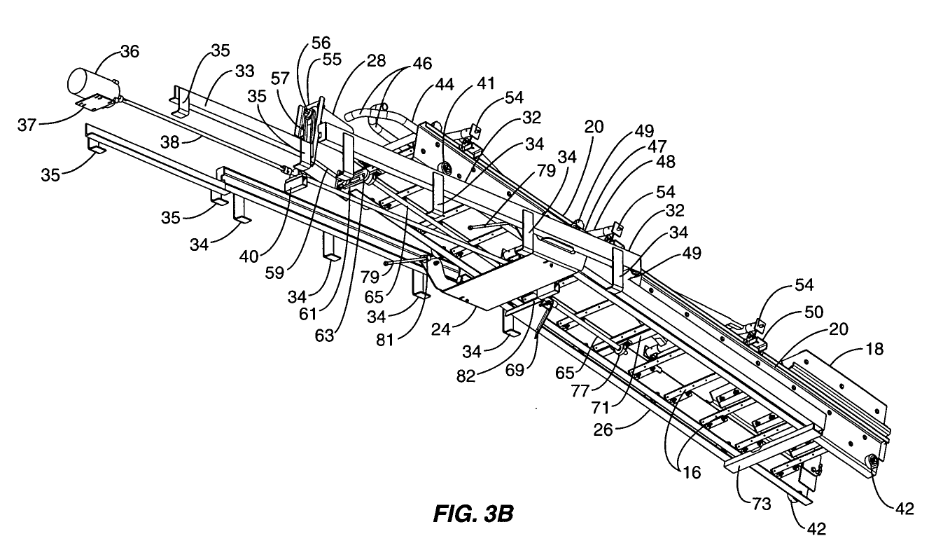

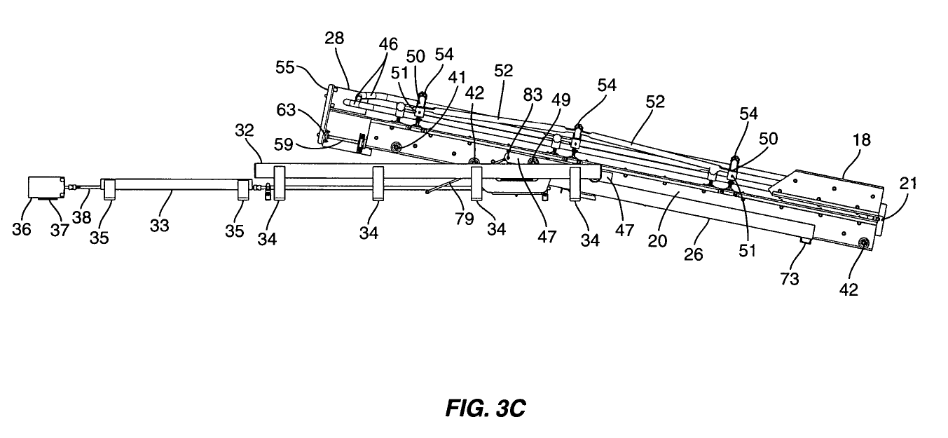

FIGS. 2A through 2D illustrate a more detailed view of the ladder 12 in its fully retracted position. As illustrated in FIGS. 2A through 2D, the handrails 22 of the ladder 12 are comprised of an elongated pipe 44 with curved ends 46 at the top section 20 of the ladder 12. The elongated pipes 44 are supported by vertical supports 48 that are designed to insert into handrail posts 50 attached to the outer edges of the ladder 12. The handrail posts 50 contain handrail post hinges 51, so that the handrail posts 50, as supporting the vertical supports 48, can bend at a right angle inward towards the ladder 12 so that the handrails 22 can be placed on top of each other in a resting position, as illustrated in FIG. 3A and discussed below. Handrail cross member supports 52 are also provided to allow further structural support for the handrails 22. Handrail knobs 54 are contained at the top of the vertical supports 48 where they intersect with the elongated pipe 44, to terminate the ends of the vertical supports 48.

The ladder motor drive unit 28 is mounted to the top section 20 of the ladder 12 via a mounting plate 55. Ladder motor drive unit mounting bolts 58 attach the ladder motor drive unit 28 to the mounting plate 55. As previously discussed, the ladder motor drive unit 28 is activated to deploy and retract the top section 20 of the ladder 12 along the ladder rail 26 when in a tilted position. FIG. 2B illustrates a perspective view of the ladder 12 when fully deployed. Section ‘A’ in FIG. 2B is illustrated in more detail in FIG. 2C, which shows the ladder motor drive unit 28 containing a ladder motor drive unit shaft 56 that supports a ladder motor drive unit chain 57 connected to a ladder motor drive unit sprocket 60 designed to drive a ladder motor drive unit sprocket shaft 59 when the ladder motor drive unit belt chain 57 rotates. As the ladder motor drive unit shaft 56 rotates, the ladder motor drive unit sprocket shaft 59 rotates because of the chain 57 attached to the sprocket 60. A ladder sprocket chain 61 situated perpendicular to the ladder motor drive unit chain 57 moves as a result, causing a ladder screw shaft sprocket 63 to rotate, thereby rotating a ladder screw drive 65 that will pull the top section 20 of the ladder 12 along the ladder rail 26. FIG. 3B illustrates the aforementioned components from a bottom view perspective.

Further, as illustrated FIG. 2C, the carriage 24 is comprised of a carriage base 62 that is coupled to carriage supports 64 that are V-shaped. Carriage rollers 66 are attached via carriage fasteners 68 to ends of the carriage supports 24 for a total of four carriage rollers 66. The carriage rollers 66 are adapted to fit inside and roll along the roof rail 32 when the ladder 12 is retracted by the carriage motor drive unit 36. The roof rail 32 contains two roof rail slots 76. The ladder-roof rail coupler rollers 49 are adapted to fit inside the roof rail slots 76 and inside a roof rail guide 78 to fully couple the ladder 12 to the carriage 24. The ladder rail 26 contains two tabs 75 on its ends that are adapted to fit inside slots 85 contained in the body of the carriage 24 when the ladder rail 26 tilts downward parallel to the roof 14. Bumpers 87 are provided to support the ladder rail 26 when the tabs 75 fit into the slots 85. By coupling the ladder rail tabs 75 into the slots 85 on the carriage 24, when the carriage 24 is pulled forward, the carriage 24 will also pull the ladder rail 26 forward along the roof rail guide 78, thereby causing the ladder 12 to move forward on the roof 14 inside the roof rail 32. The ladder-roof rail couplers 49 roll along inside the roof rail guide 78 as the ladder rail 26 is pulled forward.

Also as illustrated in FIG. 2C, the carriage 24 contains strut holders 81 that are designed to prevent struts 79 attached to strut mounts 83 attached to the ladder-roof rail coupler 47 from extending beyond a given tilt angle. In this manner, as the top section 20 of the ladder 12 is deployed and begins to tilt downward via gravity, the struts 79 do not allow the ladder 12 to tilt downward at more of an angle than desired according to the designed length of the struts 79. The front rollers of the ladder-roof rail coupler rollers 49 are also designed to be located at the roof rail slots 76 when gravity tilts the ladder 12 downward so that a portion of the ladder-roof rail coupler 47 automatically disengages from the roof rail 32 and tilting upward toward the ground at the angle of deployment allowed by the struts 79. Only the rear ladder-roof rail coupler rollers 47 remain engaged with the roof rail 32 to support the ladder rail 26 and for the ladder 12 to be deployed down the ladder rail 26 to the ground. The rear ladder-roof rail coupler rollers 47 fit inside and are retained inside a cup (not shown) in the roof rail 32 when such rollers 47 reach the back of the roof rail 32 just before the ladder rail 26 pivots.

Also as illustrated in FIG. 2C, the carriage 24 contains a carriage screw shaft mount 80 that supports the carriage screw shaft 38 to the carriage 24. The carriage screw shaft mount 80 contains a threaded orifice that the carriage screw shaft 38 screws into. The carriage screw shaft 38 also attaches into screw shaft fixed end mount 82 mounted to the roof 14 to secure the shaft 38 at the far end. As shown in FIG. 2D, the carriage screw shaft 38 is attached to the carriage motor drive unit 36. The carriage motor drive unit 36 causes the carriage screw shaft 38 to rotate. As the carriage screw shaft 38 rotates, the carriage screw shaft mount 80 moves about the carriage screw shaft 38, thereby moving the carriage 24 forward from the screw shaft fixed end mount 82 towards the carriage motor drive unit 36. In this manner, by the carriage 24 being attached to the ladder-roof rail coupler 47, the ladder-roof rail coupler rollers 49 will be moved forward by the rear carriage rollers 66, thereby moving the top section 20 of the ladder 12 forward as previously described.

FIG. 2D illustrates a top view of the ladder 12 in its fully deployed position as an alternative view.

FIGS. 3A-3C illustrate various view of the ladder 12 when the top section 20 is fully retracted along the ladder rail 26 and the ladder 12 is ready to tilt downward to be secured inside the roof rail 32. As illustrated in FIG. 3A, the bottom section 18 of the ladder 12 has been tilted upward along the hinge 21 to rest on top of the top section 20 of the ladder 12. Typically, a person will flip up the bottom section 18 before initiating the retraction process, and flip down the bottom section 18 after a deployment process. Also note a person will typically fold the vertical support 48 for the handrails 22 downward before retraction begins. The vertical support 48 are designed to fold along the handrail post hinges 51 located in the handrail posts 50 that attach the vertical supports 48 to the ladder 12.

Also note in FIG. 3A, that the ladder-roof rail coupler roller 49 is just about to fit down inside the roof rail slot 76 so that the ladder-roof rail coupler roller 49 is inside the roof rail 32 and in front of the rear carriage rollers 66 as previously described. The ladder 12 is designed so that the weight of the top section 20 extending forward past the carriage 24 will cause the top section 20 to fall downward towards the roof 14 at a point where the front of the top section 20 of the ladder is adjacent the secondary roof rail 33. Only the ladder-roof rail coupler rollers 49 fit inside and roll along the roof rail 32. The ladder rollers 42 ride below the roof rail 32 as the ladder 12 is pulled forward by the carriage motor drive unit 36 pulling the carriage 24 forward.

The ladder 12 begins to tilt when the about half of the length of the ladder 12 is deployed or retracted, as opposed to ladder systems that require all or substantially all of the length of the ladder to be retracted or deployed before the ladder tilts. The present invention may include variations where the ladder is designed to tilt when the ladder is deployed as little as 10% of its entire length or up to 90%. Conversely stated, the ladder is retracted when only 90% of the ladder is retracted down to 10%. The closer the percentage to 50% of the ladder 12 (or top section 20) length, the less open space will be required in the rear of the vehicle to deploy and retract the ladder 12.

FIG. 3B illustrates a bottom perspective view of the ladder 12 in a partially retracted or deployed state, and is further illustrated in FIG. 3A to better illustrate certain components. Note that the ladder screw shaft 65 is fixedly attached to the ladder 12 via a ladder screw shaft fixed end mount 77. The ladder screw shaft 65 is also attached to a ladder screw shaft traverse mount 69. In this manner, the ladder motor drive unit 28 causes the ladder screw shaft 65 to rotate and move the ladder 12 up and down about the ladder screw shaft traverse mount 69, similar to the design of the carriage screw shaft mount 80 as previously described above. A ladder cross member 73 is attached perpendicular to the ladder rail 26 on its end as support for the ladder rail 26.

FIG. 3C illustrates the ladder 12 in the partially deployed or retracted state in FIGS. 3A and 3B from a side view simply to provide an alternative illustration.

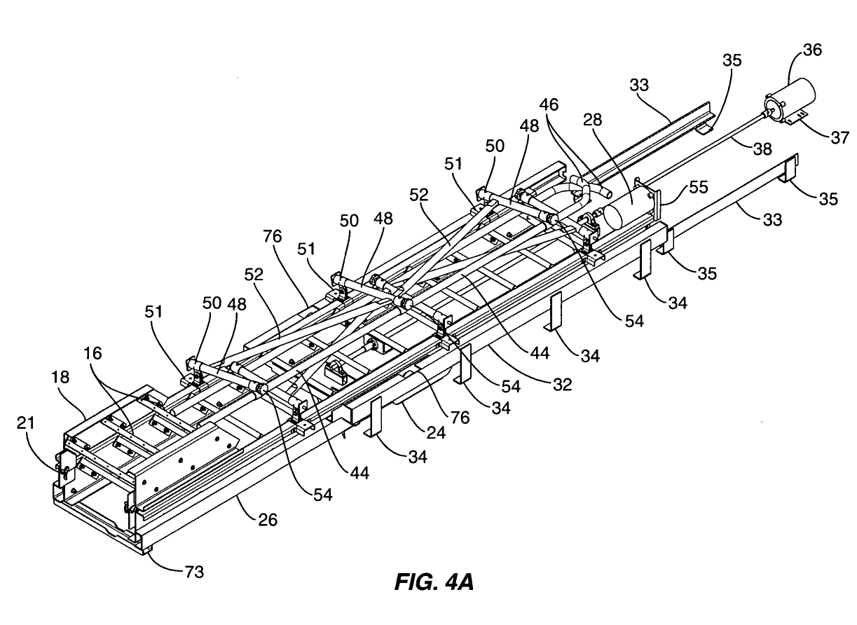

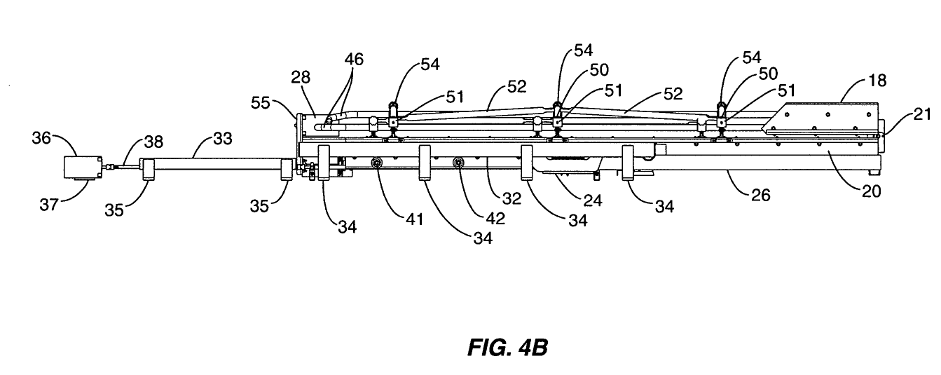

FIGS. 4A-4B illustrate the ladder 12 when the top section 20 is fully parallel to the roof 14. This occurs when either gravity pulls the top section 20 downward during retraction, or after the ladder 12 is initially deployed outward by the carriage motor drive unit 36 before the opposite end of the top section 20 and bottom section 18 tilt downward. As can be seen, the ladder-roof rail coupler rollers 49 are fully engaged and inserted inside the roof rail 32. Thus, the carriage motor drive until 36 can pull the carriage 24 to in turn pull the top section 20 of the ladder 12 forward for retraction.

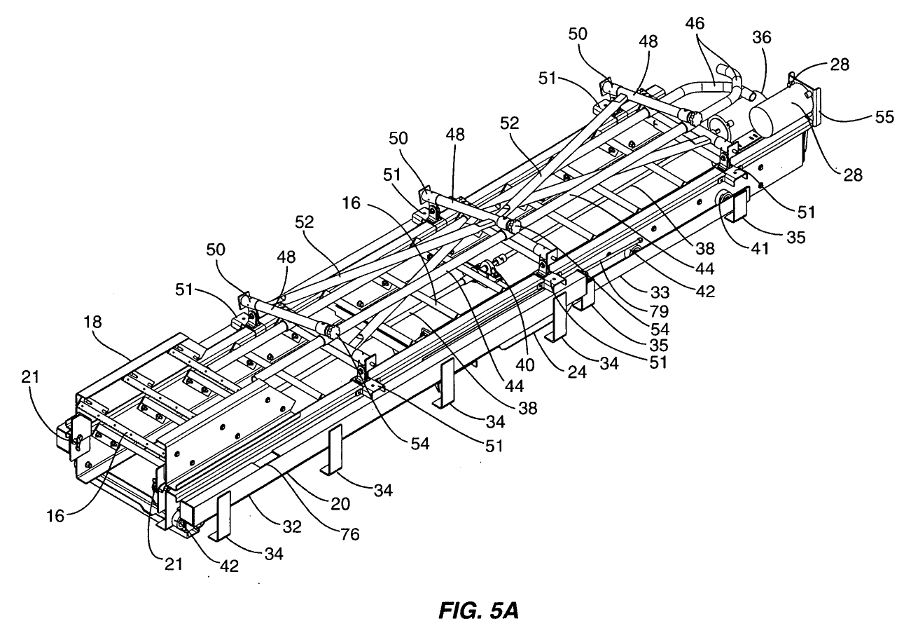

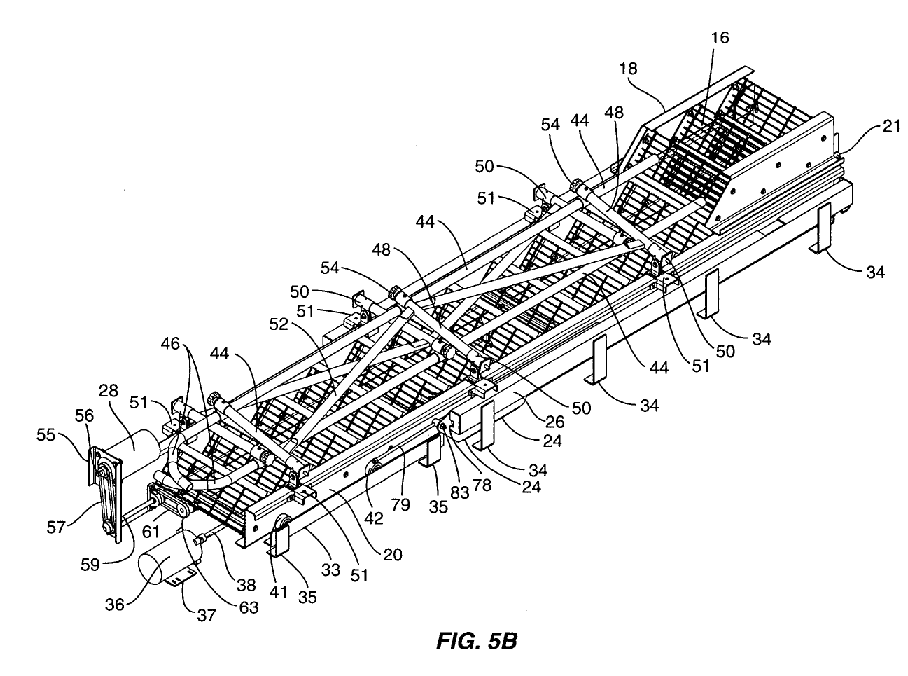

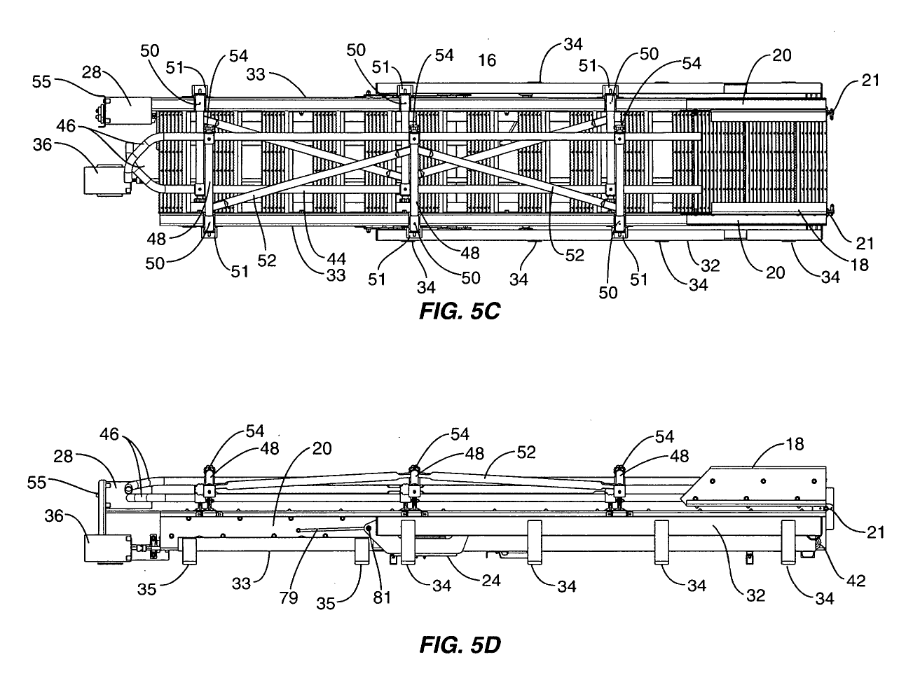

FIGS. 5A-5D illustrate the ladder 12 in a fully retracted state. Note that the top section 20 of the ladder 12 is fully retracted forward adjacent the carriage motor drive unit 36. The secondary roof rail 33 supports the ladder rollers 42. The secondary roof rail 33 is located in a lower plane than the roof rail 32 since the ladder rail rollers 42 are located in a lower plane than the ladder-roof rail coupler rollers 49 that ride inside the roof rail 32.

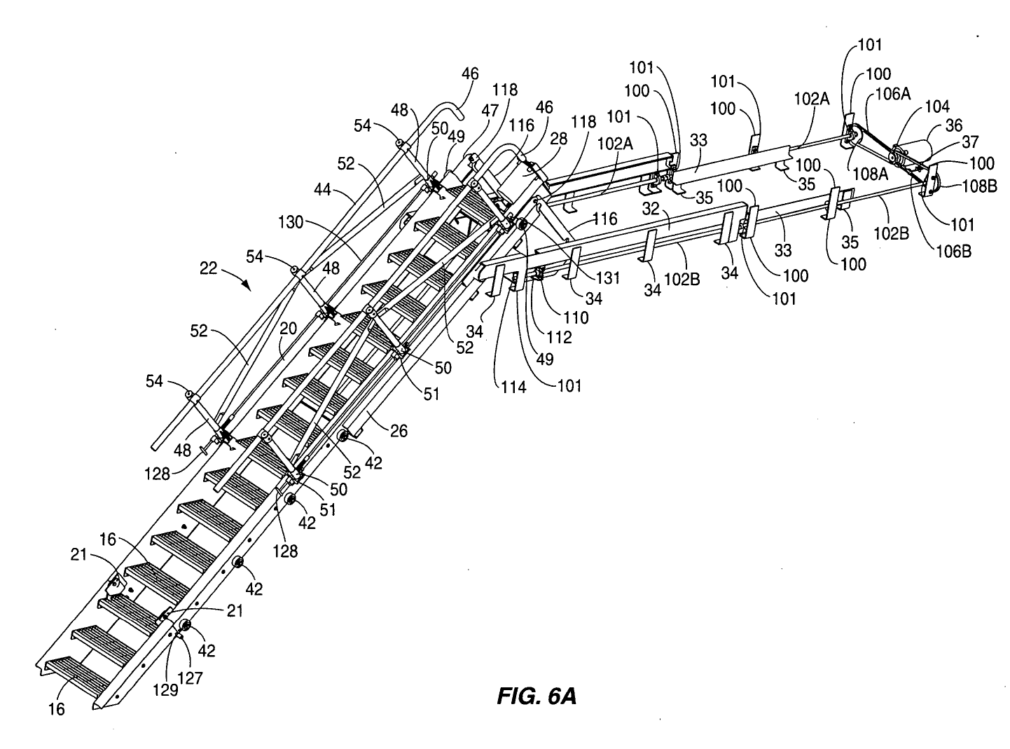

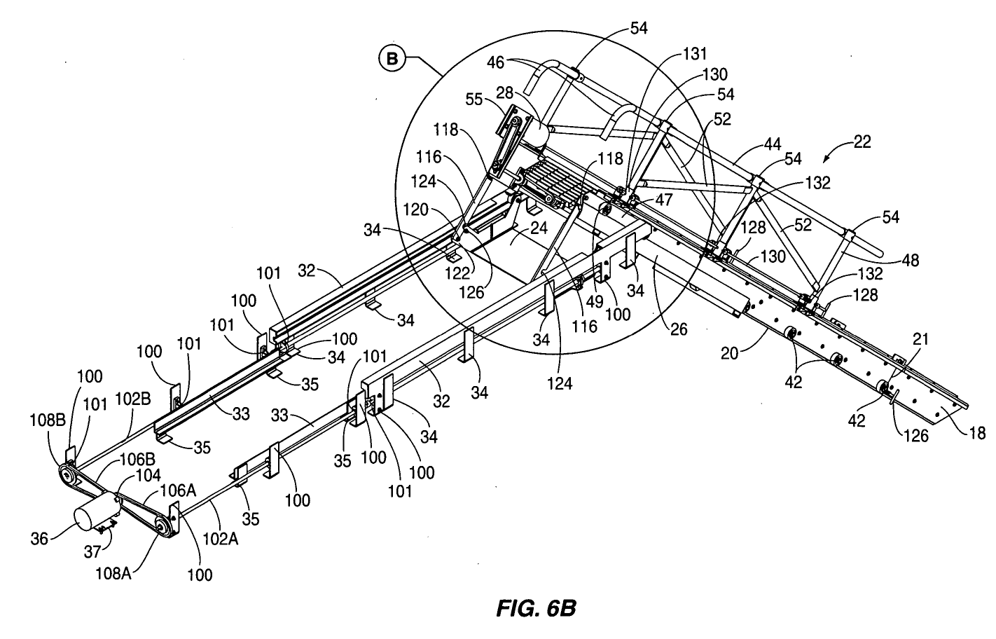

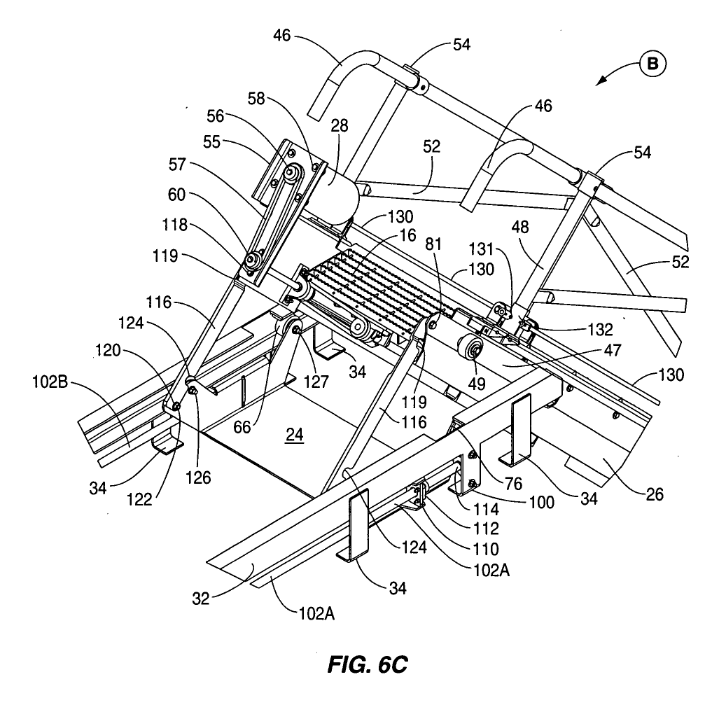

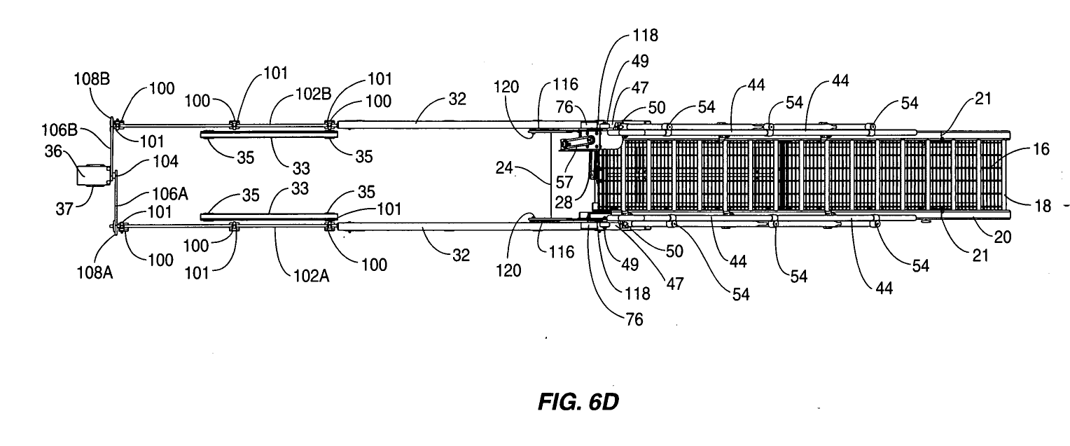

FIGS. 6A-6D illustrate an alternative embodiment of the ladder 12 similar to the ladder illustrated in FIGS. 2A-5D. The common components between the two ladder systems are labeled with the same numbers. In the ladder 12 illustrated in FIG. 6A, bearing mounts 100 are provided along the roof 14 to support pillow block bearings 101 that carry 102A and 102B carriage drive screws. Two carriage screw shafts 102A, 102B as opposed to one screw drive shaft is provided. The two carriage screw shafts 102A, 102B are provided on each side of a center axis through the carriage motor drive unit 36 where the screw drive shaft 38 was provided in the ladder 12 of FIGS. 2A-5D. In this manner, the carriage screw shafts 102A, 102B are moved out of the walking area of the roof 14.

The rotating shaft 104 out of the carriage motor drive unit 36 is coupled to two chains 106A, 106B, one chain for each sprocket 108A, 108B for each carriage screw shaft 102A, 102B. In this manner, the carriage motor drive unit 36 drives both the carriage screw shafts 102A, 102B at the same time in unison to move the carriage 24 along the roof 14 to deploy and retract the ladder 12. The carriage screw shafts 102A, 102B are fixedly mounted to carriage screw shaft fixed end mounts 114 attached to the bearing mounts 100 located farthest from the carriage motor drive unit 36. The carriage 24 also provides two carriage screw shaft mounts 110, one for each carriage screw shaft 102A, 102B. The carriage screw shaft mounts 110 contain threaded orifices 112 about which the carriage screw shafts 102A, 102B are inserted and rotate about to move the carriage 24 up and down the carriage screw shafts 102A, 102B.

FIG. 6B, a perspective rear view of the ladder 12 illustrated in FIG. 6A, illustrates an alternative locking system for the lower portion 18 of the ladder 12 so that the lower portion 18 is locked in place when extended about the hinge 21 to an extended position. As illustrated in FIG. 6B, a spring-loaded dead bolt system is employed. A locking handle 126 is attached to a dead bolt 127 and is used to extend the dead bolt 127 (illustrated in FIG. 6A) through orifices 129 located on opposite sides of the ladder 12. In this manner, when the lower portion 18 is extended from the top section 20 of the ladder 12, the locking handle 126 is engaged or pushed to extend the dead bolt 127 through the orifice 129 on the opposite side of the locking handle 126. In this manner, the lower portion 18 is locked into place and cannot be folded or retracted back onto the top section 20 of the ladder 12 as a safety feature. When the lower portion 18 is desired to be retracted, the locking handle 126 is pulled to retract the dead bolt 127, which will allow the lower portion 18 to be folded about hinge 21.

The alternative ladder embodiment also contains a locking system for the handrails 22 similar to that of the lower portion 18 of the ladder 12. As illustrated in FIG. 6B, a spring-loaded locking handle 128 is provided that is attached to a dead bolt 130. The dead bolt 130 extends through orifices 132 provided through the vertical supports 48 of the handrails 22. When it is desired to extend the handrails 44 upright and lock them into place, the locking handle 128 is rotated to release energy in a spring (not shown) which pulls the dead bolt 130 up the ladder to extend into an ending orifice 131. The locking handle 128 in effect is spring-assisted. When the dead bolt 130 is extended through the end orifice 131, its blocks its proximate vertical support 48 from folding inward by blocking the handrail post hinge 51. In this manner, the handrails 22 will not accidentally fall downward when in use. When it is desired to retract the handrails 22 to lay down on top of the ladder 12 when it is to be retracted, the locking handle 128 is pulled against the spring to retract the dead bolt 130 from the end orifice 131, which allows the vertical support 48 to be rotated about the handrail post hinge 51. The locking handle 128 is rotated to lock the energy in the spring in place so that it can be released to provide spring-assistance when locking is desired, as discussed above.

Another difference is provided in the linkage between the ladder-roof rail coupler 47 and the carriage 24 that controls the maximum tilt angle of the ladder rail 26 and thus the ladder 12 when retracted. In the ladder 12 of FIGS. 2A-5D, struts 79 are provided that are fixedly attached to strut mounts 83 on the ladder-roof rail coupler 47, and slidably linked to strut holders 81 attached to the carriage 24. In the alternative ladder embodiment, as illustrated in FIG. 6C, a close up view of the carriage 24, a linkage having fixedly attached ends on both the carriage 24 and the ladder-roof rail coupler 47 is provided. This allows the carriage 24 movement to control the speed at which the ladder-roof rail coupler 47, and thus the ladder rail 26 and ladder 12, pivots to tilt downward before the ladder 12 is deployed towards the ground.

As illustrated in FIG. 6C, a fixed strut 116 is provided to attach the ladder-roof rail coupler 47 to the carriage 24. The fixed strut 116 is fixedly attached to the ladder-roof rail coupler 47 by strut holders 81. The fixed strut 116 is also fixedly attached to the carriage 24 using a carriage bolt 120 placed through an orifice 122 in the fixed strut 116.

The fixed strut 116 contains two grooves 119, 124 on each end. Before the ladder 12 has begun to tilt downward during deployment, the grooves 119, 124 are coupled with carriage bolts 126, 127 to allow the fixed strut 116 to rest in a parallel position to the roof 14 when the ladder 12 is parallel to the roof 14 inside the roof rail 32. When the carriage motor drive unit 36 rotates the carriage screw shafts 102A, 102B to deploy the ladder 12, and when the ladder-roof rail coupler rollers 49 move underneath the roof rail slots 76 and are released, the ladder-roof rail coupler 47 is fixedly held by the fixed strut 116. Only by the carriage 24 continuing to be moved outward is the ladder-roof rail coupler 47 allowed to move upward to tilt the ladder rail 26 and ladder 12 downward. The speed at which the carriage motor drive unit 36 rotates the carriage screw shaft 102A, 102B controls the speed at which the ladder rail 26 is tilted. Gravity pulling on the ladder rail 26 does not control the speed at which the ladder rail 26 is tilted in this embodiment unlike the ladder 12 illustrated in FIGS. 2A-5D. The ladder rail 26 is only allowed to be tilted according to the distance the carriage 26 is moved in combination with the length of the fixed strut 116.

FIG. 6D illustrates a top view of the alternative ladder embodiment of the ladder in FIGS. 6A-6C in its fully deployed position as an alternative view.

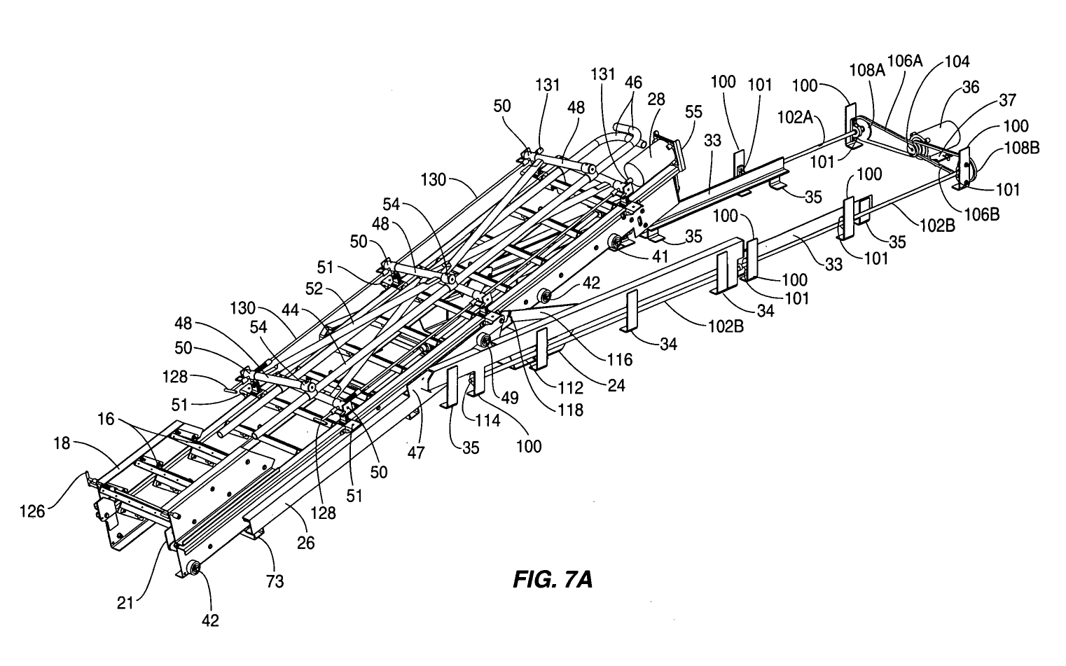

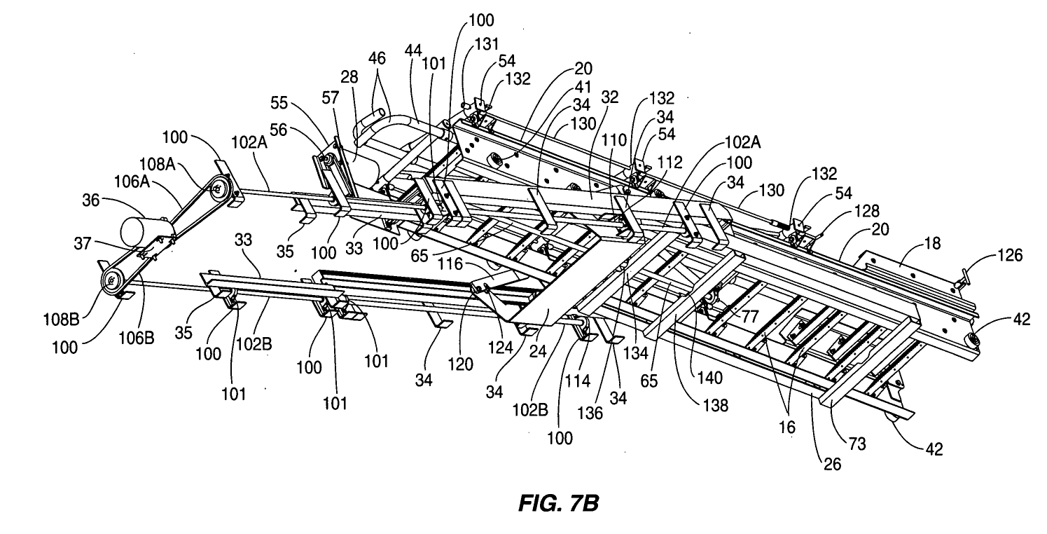

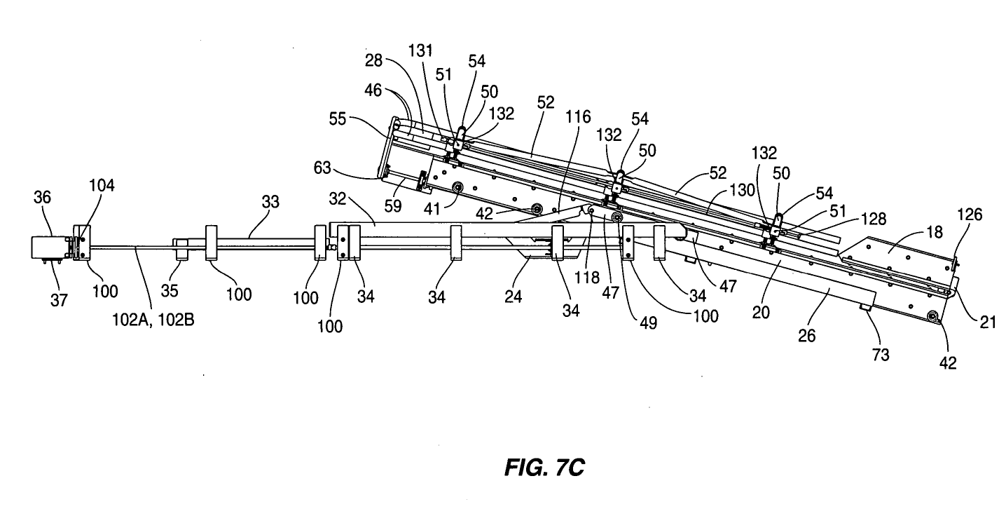

FIGS. 7A-7C illustrate various views of the alternative ladder 12 embodiment when the top section 20 is fully retracted along the ladder rail 26 and the ladder 12 is ready to tilt downward to be secured inside the roof rail 32. As illustrated in FIG. 3A, the bottom section 18 of the ladder 12 has been tilted upward along the hinge 21 to rest on top of the top section 20 of the ladder 12. Typically, a person will flip up the bottom section 18 before initiating the retraction process, and flip down the bottom section 18 after a deployment process. Also note a person will typically fold the vertical supports 48 for the handrails 22 downward before retraction begins. The vertical support 48 are designed to fold along the handrail post hinges 51 located in the handrail posts 50 that attach the vertical supports 48 to the ladder 12.

Further note in FIG. 3A, that the ladder-roof rail coupler roller 49 is just about to fit down inside the roof rail slot 76 so that the ladder-roof rail coupler roller 49 is inside the roof rail 32 and in front of the rear carriage rollers 66, as previously described. The ladder 12 is designed so that the weight of the top section 20 extending forward past the carriage 24 will cause the top section 20 to fall downward towards the roof 14 at a point where the front of the top section 20 of the ladder is adjacent the secondary roof rail 33. Only the ladder-roof rail coupler rollers 49 fit inside and roll along the roof rail 32. The ladder rail rollers 42 ride below the roof rail 32 as the ladder 12 is pulled forward by the carriage motor drive unit 36 pulling the carriage 24 forward.

The ladder 12 begins to tilt when the about half of the length of the ladder 12 is deployed or retracted, as opposed to ladder systems that require all or substantially all of the length of the ladder to be retracted or deployed before the ladder tilts.

FIG. 7B illustrates a bottom perspective view of the alternative ladder 12 embodiment in a partially retracted or deployed state. Note that the ladder screw drive 65 is located in approximately the center of the long axis of the ladder 12.

FIG. 7C illustrates the ladder 12 in the partially deployed or retracted state in FIGS. 7A and 7B from a side view simply to provide an alternative illustration.

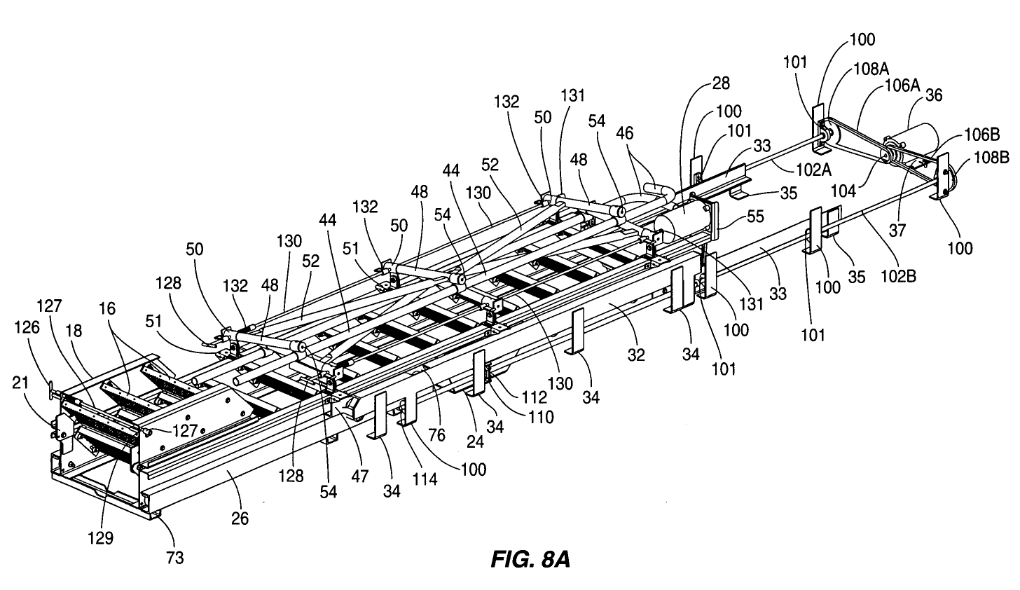

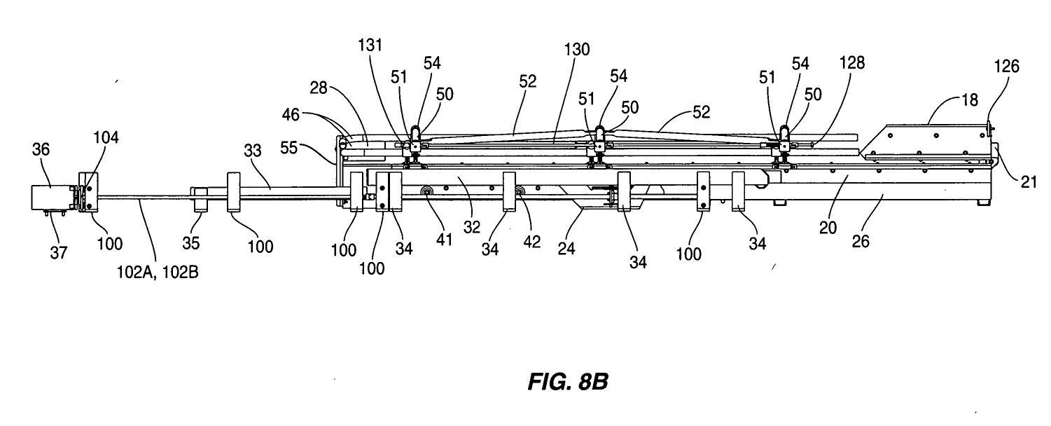

FIGS. 8A-8B illustrate the alternative ladder 12 embodiment when the top section 20 is fully parallel to the roof 14. This occurs when the carriage motor drive unit 36 pulls the carriage 24 forward, which in turn causes the fixed strut 116 to pull on the ladder-roof rail coupler 47 and ladder rail 26 downward in a clockwise direction until the ladder-roof rail coupler 47 is engaged with the roof rail 32 and the ladder rail 26 is parallel to the roof 14. As can be seen, the ladder-roof rail coupler rollers 49 are fully engaged and inserted inside the roof rail 32. Thus, the carriage motor drive unit 36 can pull the carriage 24 to in turn pull the top section 20 of the ladder 12 forward for retraction.

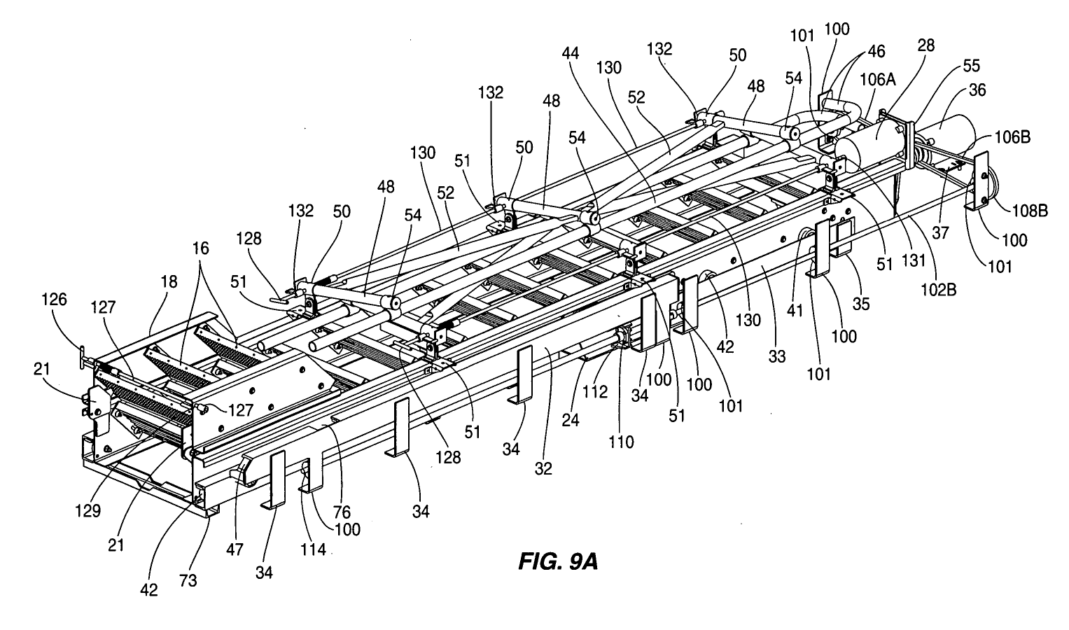

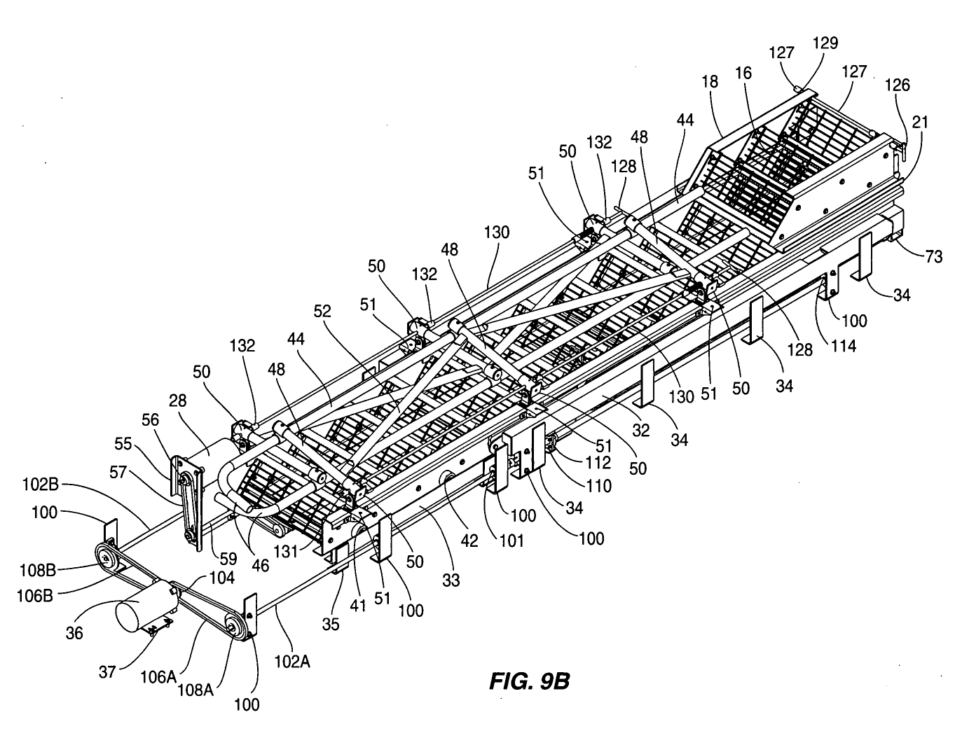

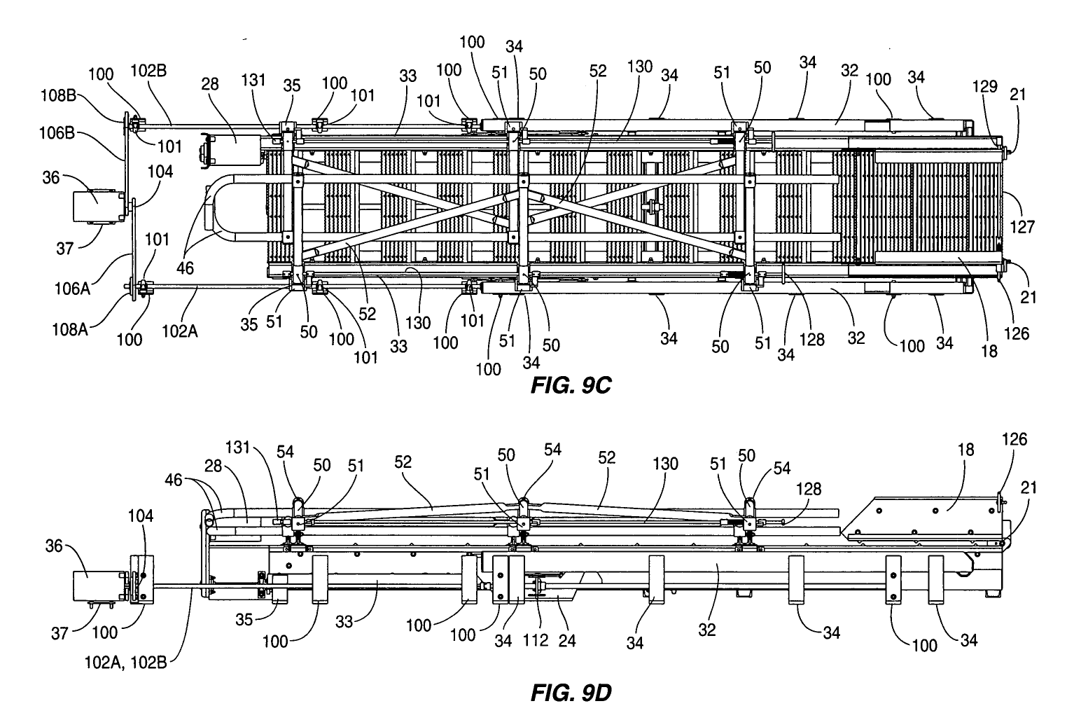

FIGS. 9A-9D illustrate the alternative ladder embodiment with the ladder 12 in a fully retracted state. Note that the top section 20 of the ladder 12 is fully retracted forward adjacent the carriage motor drive unit 36. The secondary roof rail 33 supports the ladder rollers 42. The secondary roof rail 33 is located in a lower plane than the roof rail 32, since the ladder rail rollers 42 are located in a lower plane than the ladder-roof rail coupler rollers 49 that ride inside the roof rail 32.

Note that the ladder 12 and the support components, including but not limited to the carriage 24, ladder rail 26, roof rail 32, secondary roof rail 33, handrails 22 and other components, may be manufactured out of any type of material, including metal, steel and aluminum as examples. The motor drive units 28, 36 may be any type of motor drive unit, including AC or DC driven. The motor drive units 28, 36 may be screw drive shafts, or may be designed to retract the ladder 12 using chains and sprockets or any other type of pulling and pushing system.

Those skilled in the art will recognize improvements and modifications to the preferred embodiments of the present invention. All such improvements and modifications are considered within the scope of the concepts disclosed herein and the claims that follow.

What is claimed is:

1. A two-rail vehicle ladder deployment and retraction device, comprising:
a ladder comprising a plurality of steps, wherein the ladder is coupled to a ladder rail, and wherein a ladder drive unit is attached to the ladder and controls the traversal of the ladder along the ladder rail; and
a carriage coupled to a roof rail mounted on a roof of the vehicle, wherein a carriage drive unit is coupled to the carriage to control the traversal of the carriage along the roof rail;
wherein during a first deployment stage, the carriage drive unit moves the carriage to move the ladder rail from a storage position towards the rear of the vehicle and tilts the ladder rail downward towards the ground; and
wherein during a second deployment stage, the ladder drive unit moves the ladder downward along the ladder rail towards the ground.

2. The device of claim 1, further comprising a ladder-roof rail coupler to the ladder rail, wherein the carriage drive unit causes the ladder and ladder rail to traverse along the roof rail when the ladder-roof rail is engaged in the roof rail.

3. The device of claim 2, wherein during the first deployment stage, the carriage drive unit tilts the ladder rail downward by partially disengaging the ladder-roof rail coupler from the roof rail.

4. The device of claim 2,
wherein during a first retraction stage, the ladder drive unit moves the ladder upward along the ladder rail towards the roof of the vehicle; and
wherein during a second retraction stage, the carriage drive unit moves the carriage to retract the ladder rail and the ladder to a storage position towards the front of the vehicle.

5. The device of claim 1, further comprising a ladder-roof rail coupler attached to the ladder rail, wherein the carriage drive unit causes the ladder and ladder rail to traverse along the roof rail when the ladder-roof rail is engaged in the roof rail.

6. The device of claim 4, wherein during the first retraction stage, the ladder-roof rail coupler is partially engaged with the roof rail to engage the ladder-roof rail coupler to the roof rail.

7. The device of claim 1, wherein the ladder is comprised of a top section and a bottom section attached to the top section using a hinge, wherein the bottom section is adapted to flip up onto and rest on the top section to shorten the length of the ladder when stored.

8. The device of claim 1, further comprising a ladder screw shaft that couples the ladder drive unit to the ladder to control the traversal of the ladder along the ladder rail.

9. The device of claim 1, further comprising a carriage screw shaft that couples the carriage drive unit to the carriage to control the traversal of the carriage along the roof rail.

10. The device of claim 9, further comprising a second carriage screw shaft that couples the carriage drive unit to the carriage, wherein the carriage drive unit drives the carriage screw shaft and the second carriage screw shaft to control the traversal of the carriage along the roof rail.

11. The device of claim 1, wherein the carriage contains one or more carriage rollers that are coupled inside the roof rail such that the one or more carriage rollers roll inside the roof rail when the carriage traverses the roof rail.

12. The device of claim 1, wherein the ladder contains one or more ladder rollers that are coupled inside the ladder rail such that the one or more ladder rollers roll inside the ladder rail when the ladder traverses the ladder rail.

13. The device of claim 2, wherein the ladder-roof rail coupler contains ladder-roof rail coupler rollers that are coupled inside the roof rail such that the ladder-roof rail coupler rollers roll inside the roof rail when the ladder-roof rail coupler is fully engaged with the roof rail.

14. The device of claim 13, wherein the roof rail contains a roof rail slot that is adapted to release the ladder-roof rail coupler roller to partially release the ladder-roof rail coupler from the roof rail to tilt the ladder rail towards the ground when the ladder-roof rail coupler roller is located in the roof rail slot.

15. The device of claim 1, further comprising handrails that are coupled to the ladder.

16. The device of claim 15, further comprising handrail posts hingedly attached to the ladder via handrail post hinges, wherein the handrails are supported by the handrail posts, and wherein the handrails are adapted to be folded down onto the ladder about the handrail post hinges.

17. The device of claim 1, further comprising a secondary roof rail attached to the roof of the vehicle and located between the front of the vehicle and the roof rail, wherein the secondary roof rail is adapted to receive and support the ladder when stored.

18. The device of claim 8, wherein the ladder drive unit is coupled to the ladder screw shaft to cause the ladder screw shaft to rotate via a sprocket and chain system.

19. The device of claim 2, further comprising at least one strut fixedly attached to the ladder-roof rail coupler, wherein the at least one strut stops the ladder-roof rail coupler from tilting further downward towards the ground after being partially disengaged from the roof rail.

20. The device of claim 19, wherein the at least one strut is fixedly attached to the carriage on its end opposite of attachment to the ladder-roof rail coupler.

21. The device of claim 7, wherein the bottom section contains two aligned orifices on each side of the bottom section, and further comprising a handle lock attached to a dead bolt that is coupled to one of the two aligned orifices when the handle lock is unlocked and is coupled to both of the two aligned orifices when the handle lock is locked to prevent the bottom portion from moving about the hinge.

22. The device of claim 16, wherein the handrail posts contains orifices that are aligned with each other in a direction parallel to the ladder rail, and further comprising a handle lock attached to a dead bolt that is coupled to a subset of the aligned orifices when the handle is unlocked and is coupled to all of the aligned orifices when the handle lock is locked to prevent one or more of the handrail posts from moving about the handrail post hinge to keep the handrail posts upright.

23. A method for deploying and retracting a ladder from a vehicle, comprising:
driving a carriage during a first deployment stage using a carriage drive unit to drive a ladder rail supporting the ladder away from the front of the vehicle along a roof rail mounted on the roof of the vehicle until the ladder tilts downward towards the ground;
driving the ladder from the ladder rail towards the ground during a second deployment stage using a ladder drive unit.

24. The method of claim 23, wherein driving the carriage further comprises driving a ladder-roof rail coupler attached to the ladder rail, wherein the ladder-roof rail is coupled to the roof rail during the first deployment stage.

25. The method of claim 24, further comprising disengaging the ladder-roof rail coupler from the roof rail before the step of driving the ladder during the second deployment stage.

26. The method of claim 23,
driving the ladder during a first retraction stage using the ladder drive unit up along the ladder rail; and
driving the carriage using the carriage drive unit during a second retraction stage towards the front of the vehicle and along to the roof rail that is mounted on the roof of the vehicle, until the ladder reaches a storage position.

27. The method of claim 26, wherein driving the carriage during a second retraction stage further comprises driving a ladder-roof rail coupler attached to the ladder rail.

28. The method of claim 27, further comprising engaging the ladder-roof rail coupler to the roof rail before the step of driving the carriage during the second retraction stage.

29. The method of claim 26 further comprising flipping up a bottom section of the ladder onto and resting on a top section of the ladder to shorten the length of the ladder when stored before driving the ladder in the first retraction stage.

30. The method of claim 23, wherein driving the carriage during the first deployment stage further comprises driving a carriage screw shaft that couples the carriage drive unit to the carriage to control the traversal of the carriage along the roof rail.

31. The method of claim 26, wherein driving the ladder during the second deployment stage further comprises driving a ladder screw shaft that couples the ladder drive unit to the ladder to control the traversal of the ladder along the ladder rail.

32. The method of claim 26, wherein driving the ladder during the first retraction stage further comprises driving a ladder screw shaft that couples the ladder drive unit to the ladder to control the traversal of the ladder along the ladder rail.

33. The method of claim 26, wherein driving the carriage during the second retraction stage further comprises driving a carriage screw shaft that couples the carriage drive unit to the carriage to control the traversal of the carriage along the roof rail.

34. The method of claim 23, further comprising storing a portion of the ladder on a secondary roof rail attached to the roof of the vehicle and located between the front of the vehicle and the roof rail.

35. The method of claim 24, wherein driving the carriage during a first deployment stage further comprises the carriage driving a strut fixedly attached to the carriage and the ladder-roof rail coupler to tilt the ladder downward towards the ground.

36. The method of claim 26, wherein driving the carriage during a second retraction stage further comprises the carriage pulling a strut fixedly attached to the carriage and the ladder-roof rail coupler to tilt the ladder upward to a position parallel to the roof rail.

37. The method of claim 29, further comprising unlocking a handle attached to the bottom section of the ladder before flipping up the bottom section.

38. The method of claim 23, further comprising lifting up a handrail hingedly attached to the ladder after driving the carriage in a second deployment stage.

39. The method of claim 26, further comprising pushing down a handrail hingedly attached to the ladder before driving the ladder in the first retraction stage.

40. The method of claim 39, further comprising unlocking a handle attached to the handrail before pushing down the handrail.
